(19) United States
(12) Patent Application Publication
(10) Pub. No.: US 2014/0111182 A1
(43) Pub. Date: Apr. 24, 2014

(54) REFERENCE VOLTAGE GENERATION CIRCUIT

(71) Applicant: LAPIS SEMICONDUCTOR CO., LTD., Kanagawa (JP)

(72) Inventor: Akira AKAHORI, Kanagawa (JP)

(73) Assignee: LAPIS SEMICONDUCTOR CO., LTD., Kanagawa (JP)

(21) Appl. No.: 14/053,787

(22) Filed: Oct. 15, 2013

(30) Foreign Application Priority Data
Oct. 22, 2012 (JP) 2012-232607

(51) Int. Cl. G05F 3/16

(52) U.S. Cl. CPC G05F 3/16
USPC 323/313

(57) ABSTRACT

A reference voltage generation circuit includes a standard electrical current path including at least a pair of NMOS and PMOS, and a constant electrical current supplying circuit for supplying a constant electrical current to the standard electrical current path. The pair of NMOS and PMOS is configured to share a gate potential and a source-drain electrical current. Accordingly, the reference voltage generation circuit is configured to generate a reference voltage as a potential difference between two positions sandwiching the NMOS and PMOS. The reference voltage generation circuit further includes a timing compensation circuit. The timing compensation circuit includes a compensation DMOS for forming a detour electrical current path for bypassing the NMOS according to an on signal.

### BACKGROUND OF THE INVENTION AND RELATED ART STATEMENT

The present invention relates to a reference voltage generation circuit for generating a reference voltage.

Patent References 1 and 2 have disclosed a conventional reference voltage generation circuit for generating a reference voltage for an operation of a circuit disposed in a semiconductor device. In the conventional reference voltage generation circuit disclosed in Patent References 1 and 2, an enhancement type MOS transistor and a depletion type MOS transistor, which are connected in series, are arranged between a power source potential and a ground potential.

Patent Reference 1: Japanese Patent Publication No. 2011-029912

Patent Reference 2: Japanese Patent Publication No. 2002-110917

In the conventional reference voltage generation circuit disclosed in Patent References 1 and 2, the enhancement type MOS transistor tends to be susceptible to a variance in the power source voltage, and to be stable against a change in a temperature. On the other hand, the depletion type MOS transistor tends to be stable against the variance in the power source voltage, but tends to be susceptible to the change in the temperature. Accordingly, when the two types of MOS transistors are combined, it is possible to compensate weakness thereof.

In the conventional reference voltage generation circuit disclosed in Patent References 1 and 2, the reference voltage is determined according to an on resistivity value of the two types of MOS transistors. Further, the reference voltage is input into gates of the two types of MOS transistors. Accordingly, for example, when the reference voltage increases, the on resistivity value of the two types of MOS transistors is decreased, thereby decreasing the reference voltage. On the other hand, when the reference voltage decreases, the on resistivity value of the two types of MOS transistors is increased, thereby increasing the reference voltage. Accordingly, it is possible to maintain the reference voltage at a constant level through the increase or decrease in the on resistivity value.

In the conventional reference voltage generation circuit disclosed in Patent References 1 and 2, it is desirable to reduce power consumption thereof. To this end, it may be configured such that the conventional reference voltage generation circuit operates or stops operating in conjunction with an operation or a termination of a circuit to which the reference voltage is supplied. In this case, every time when the conventional reference voltage generation circuit is transited from the termination state to the operation state, the conventional reference voltage generation circuit generates the reference voltage. In order to quickly stabilize the operation of the circuit to which the reference voltage is supplied, it is necessary to stabilize the reference voltage within a short period of time.

However, in general, the enhancement type MOS transistor tends to take a long time from when the reference voltage is input into the gate thereof to when the enhancement type MOS transistor is turned on. Accordingly, the enhancement type MOS transistor tends to generate a so-called overshoot when the enhancement type MOS transistor generates the reference voltage. As a result, immediately after the reference voltage is raised, the reference voltage tends to become an unstable state, thereby negatively affecting the operation of the circuit to which the reference voltage is supplied.

In view of the problems described above, an object of the present invention is to provide a reference voltage generation circuit capable of solving the problems of the conventional reference voltage generation circuit. In the reference voltage generation circuit, it is possible to minimize the overshoot when the reference voltage is raised up.

Further objects and advantages of the invention will be apparent from the following description of the invention.

### SUMMARY OF THE INVENTION

In order to attain the objects described above, according to a first aspect of the present invention, a reference voltage generation circuit includes a standard electrical current path including at least a pair of NMOS and PMOS, and a constant electrical current supplying circuit for supplying a constant electrical current to the standard electrical current path. The pair of NMOS and PMOS is configured to share a gate potential and a source-drain electrical current. Accordingly, the reference voltage generation circuit is configured to generate a reference voltage as a potential difference between two positions sandwiching the NMOS and PMOS.

According to the first aspect of the present invention, the reference voltage generation circuit further includes a timing compensation circuit. The timing compensation circuit includes a compensation DMOS for forming a detour electrical current path for bypassing the NMOS according to an on signal.

In the reference voltage generation circuit of the present invention, it is possible to minimize an overshoot when the reference voltage is raised up.

### BRIEF DESCRIPTION OF THE DRAWINGS

FIG. 1 is a circuit diagram showing a configuration of a reference voltage generation circuit according to a first embodiment of the present invention;

FIG. 2 is a time chart schematically showing wave shapes of input signals and a reference voltage of the reference voltage generation circuit when an enable signal becomes a high level according to the first embodiment of the present invention;

FIG. 3 is a time chart schematically showing simulation wave shapes of the input signals and the reference voltage of the reference voltage generation circuit immediately after the enable signal becomes the high level according to the first embodiment of the present invention;

FIG. 4 is a circuit diagram showing a configuration of a reference voltage generation circuit according to a second embodiment of the present invention;

FIG. 5 is a circuit diagram showing a configuration of a pulse generation circuit of the reference voltage generation circuit according to the second embodiment of the present invention;

FIG. 6 is a time chart schematically showing wave shapes of input signals of the pulse generation circuit of the reference voltage generation circuit according to the second embodiment of the present invention; and

FIG. 7 is a circuit diagram showing a configuration of a reference voltage generation circuit according to a third embodiment of the present invention.

### DETAILED DESCRIPTION OF PREFERRED EMBODIMENTS

Hereunder, preferred embodiments of the present invention will be explained with reference to the accompanying drawings.

### First Embodiment

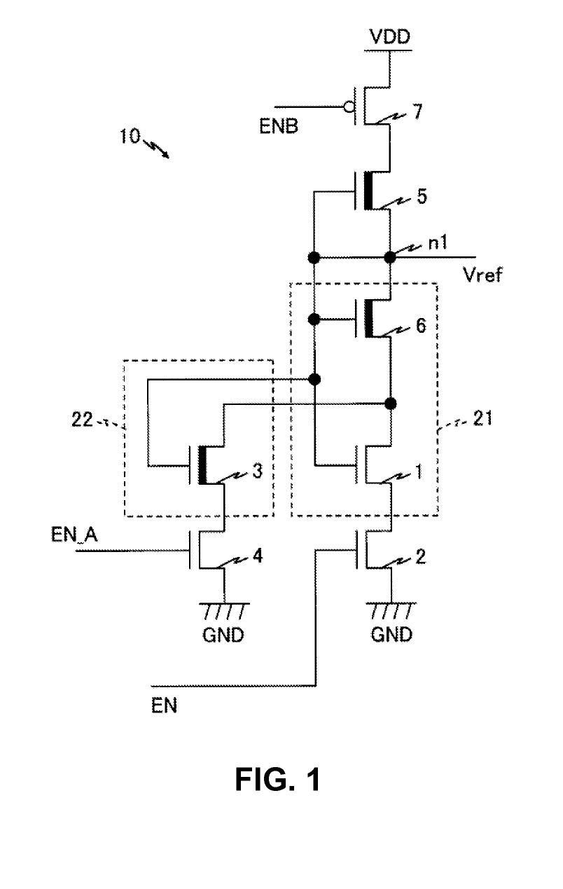

A first embodiment of the present invention will be explained. FIG. 1 is a circuit diagram showing a configuration of a reference voltage generation circuit 10 according to the first embodiment of the present invention.

As shown in FIG. 1, the reference voltage generation circuit 10 includes an enhancement type NMOS field effect transistor (referred to as an NMOS) 1 and a depletion type NMOS field effect transistor (referred to as a DMOS) 6. A drain of the NMOS 1 is connected to a source of the DMOS 6. Further, a drain of the DMOS 6, a gate of the DMOS 6, and a gate of the NMOS 1 are connected to an output terminal n1.

In the first embodiment, the NMOS 1 and the DMOS 6 are operated as variable resistors having an on resistivity value changing according to a reference voltage Vref generated at the output terminal n1. Further, the NMOS 1 and the DMOS 6 are arranged such that a gate potential thereof and a source-drain electrical current thereof are commonly shared. A potential between two positions sandwiching the NMOS 1 and the DMOS 6 is output as the reference voltage Vref to the output terminal n1. In the following description, the configuration including the NMOS 1 and the DMOS 6 is also referred to as a standard electrical current path 21.

As shown in FIG. 1, the reference voltage generation circuit 10 further includes a depletion type NMOS field effect transistor (referred to as a DMOS) 5. A source and a gate of the DMOS 5 are connected to the output terminal n1. The gate of the DMOS 5 is also connected to the source of the DMOS 5, so that the gate of the DMOS 5 is operated as a constant electrical current source.

In the first embodiment, the reference voltage generation circuit 10 further includes an enhancement type NMOS field effect transistor (referred to as an NMOS) 2. It is configured such that an enable signal EN (referred to also as a conductive signal) is input into a gate of the NMOS 2. Further, the NMOS 2 is operated as a switch that is turned on when the enable signal EN has a high “H” level (referred to as an enable on). In the following description, the DMOS 5 and the NMOS 2 are collectively referred to as a constant electrical current supplying circuit.

In the first embodiment, the reference voltage generation circuit 10 further includes an enhancement type PMOS field effect transistor (referred to as a PMOS) 7. A source of the PMOS 7 is connected to the drain of the DMOS 5. It is configured such that a power source voltage VDD is supplied to a drain of the PMOS 7, and an inversion signal of the enable signal EN (referred to as an enable inversion signal) ENB is input into a gate of the PMOS 7. Further, the PMOS 7 is operated as a switch that is turned on when the inversion enable signal ENB has a low “L” level.

In the first embodiment, the reference voltage generation circuit 10 further includes a depletion type NMOS field effect transistor (referred to as a DMOS) 3 and an enhancement type NMOS field effect transistor (referred to as an NMOS) 4. A drain of the DMOS 3 is connected to the drain of the NMOS 1, and a source of the DMOS 3 is connected to a drain of the NMOS 4. Further, a gate of the DMOS 3 is connected to the output terminal n1. It is configured such that a ground potential GND is supplied to a source of the NMOS 4, and an enable pulse signal (referred to also as an on signal) EN_A is input into the gate of the DMOS 3.

In the first embodiment, the NMOS 4 is operated as a switch that is turned on when the enable pulse signal EN_A has the high “H” level. In the following description, the DMOS 3 is referred to also as a detour electrical current path 22. Further, the DMOS 3 and the NMOS 4 are collectively referred to also as a timing compensation circuit. Further, the DMOS 3 is referred to also as a standard depletion type MOS transistor, and the DMOS 6 is referred to also as a compensation depletion type MOS transistor.

In the first embodiment, the DMOS 3 is operated as a resistor for raising the reference voltage Vref to a desirable specific voltage value immediately after the enable on (referred to as a transition state). Further, the NMOS 1 is operated for maintaining the reference voltage Vref at a desirable specific voltage value according to the on resistivity value thereof after a specific period of time is elapsed after the enable on (referred to as a stable state).

In the first embodiment, the reference voltage Vref in the stable state is determined according to the on resistivity value of each of the DMOS 6 and the NMOS 1. More specifically, the reference voltage Vref in the stable state is determined by the following equation:

Vref=I×(Rtr3+Rtr1)

where Rtr3 denotes the on resistivity value of the DMOS 6; Rtr1 denotes the on resistivity value of the NMOS 1; and I denotes an electrical current value flowing into the drain of the DMOS 6.

In the first embodiment, when the reference voltage Vref increases, the on resistivity value of each of the DMOS 6 and the NMOS 1 is decreased, thereby decreasing the reference voltage Vref. On the other hand, when the reference voltage Vref decreases, the on resistivity value of each of the DMOS 6 and the NMOS 1 is increased, thereby increasing the reference voltage Vref. Accordingly, the reference voltage Vref is maintained at a constant level through increasing or decreasing the on resistivity value of each of the DMOS 6 and the NMOS 1 according to the change of the reference voltage Vref applied to the gate of each of the DMOS 6 and the NMOS 1.

It should be noted that the on resistivity value of each of the DMOS 3 and the NMOS 1, which is determined by one voltage value of the reference voltage Vref, is substantially the same or a similar value.

In general, when a ratio between a channel length and a channel width of the depletion type NMOS is the same as a ratio between a channel length and a channel width of the enhancement type NMOS, the on resistivity value of the depletion type NMOS becomes smaller than the on resistivity value of the enhancement type NMOS. For this reason, in the first embodiment, it is configured such that the ratio between the channel length and the channel width of the DMOS 3 becomes smaller than the ratio between the channel length and the channel width of the NMOS 1. When it is configured such that the on resistivity value of each of the DMOS 3 and the NMOS 1 is substantially the same or a similar value, it is possible to smoothly raise the reference voltage Vref from the transition state to the stable state.

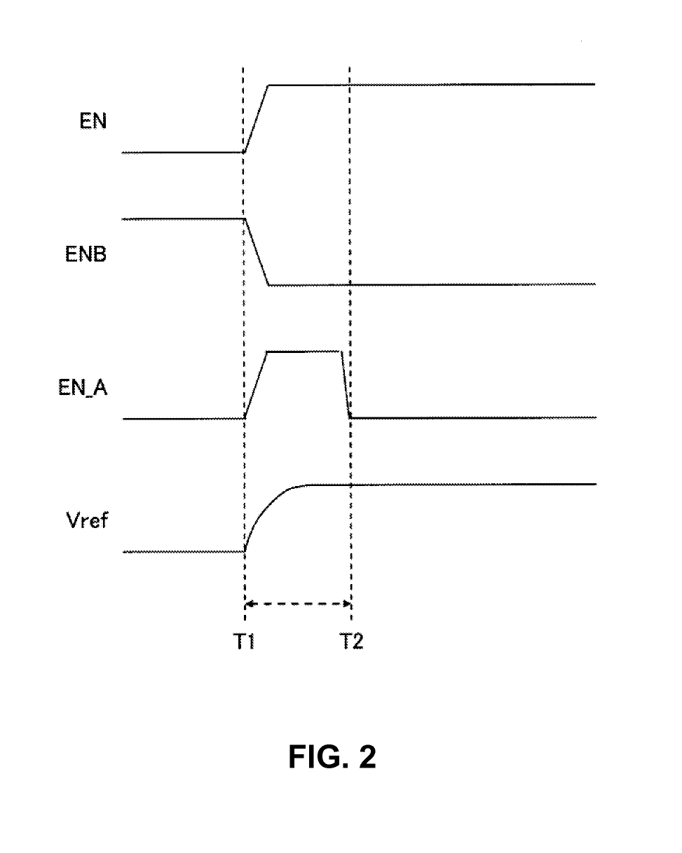

An operation of the reference voltage generation circuit 10 in the enable on will be explained next with reference to FIGS. 1 and 2. FIG. 2 is a time chart schematically showing wave shapes of input signals and the reference voltage Vref of the reference voltage generation circuit 10 when the enable signal EN becomes the high “H” level according to the first embodiment of the present invention.

As shown in FIG. 2, at a time T1, the enable signal EN is switched from the low “L” level to the high “H” level, and the enable inversion signal ENB is switched from the high “H” level to the low “L” level, respectively, that is, the enable on. At the same time, the enable pulse signal EN_A is switched from the low “L” level to the high “H” level. When the enable signal EN becomes the high “H” level, the NMOS 2 is turned on. When the enable inversion signal ENB becomes the low “L” level, the PMOS 7 is turned on. When the enable pulse signal EN_A becomes the high “H” level, the NMOS 4 is turned on.

In the first embodiment, immediately after the enable on, the NMOS 1, which is the enhancement type, is not turned on, so that the standard electrical current path 21 is not in the conductive state. On the other hand, the DMOS 3 is the depletion type having a faster switching response time, as opposed to the enhancement type, to the change in the reference voltage Vref supplied into the gate thereof. Accordingly, the DMOS 3 is turned on immediately after the enable on. As a result, the detour electrical current path 22 becomes the conductive state, and the reference voltage Vref is gradually increasing. Through the operation described above, the reference voltage Vref rises to the specific potential without an overshoot.

In the first embodiment, after a specific period of time is elapsed from the time T1, at a time T2, the enable pulse signal EN_A is switched from the high “H” level to the low “L” level. During a period of time when the enable pulse signal EN_A is in the high “H” level, that is, from the time T1 to the time T2 (referred to as a pulse existing period), the detour electrical current path 22 becomes the conductive state. It may be configured such that the pulse existing period can be set as a period of time longer than a period of time from the enable on to when the reference voltage Vref is completely raised. Further, the pulse existing period can be set as a period of time similar to or longer than a period of time from the enable on to when the NMOS 1 is turned on.

In the first embodiment, after the DMOS 3 is turned on, the NMOS 1 is turned on. More specifically, the NMOS 1 is turned on, for example, immediately before or after the pulse existing period is elapsed. When the NMOS 1 is turned on, the standard electrical current path 21 becomes the conductive state.

In the first embodiment, when the enable pulse signal EN_A is switched from the high “H” level to the low “L” level at the time T2, the DMOS 3 is turned on. More specifically, the DMOS 3 is turned on after the pulse existing period is elapsed. Accordingly, the detour electrical current path 22 becomes the non-conductive state from the time T2. On the other hand, the NMOS 1 is in the on state even after the time T2, and the standard electrical current path 21 is in the conductive state. Accordingly, as far as it is in the enable on state, even after the time T2, the reference voltage Vref is maintained at the desirable specific voltage value.

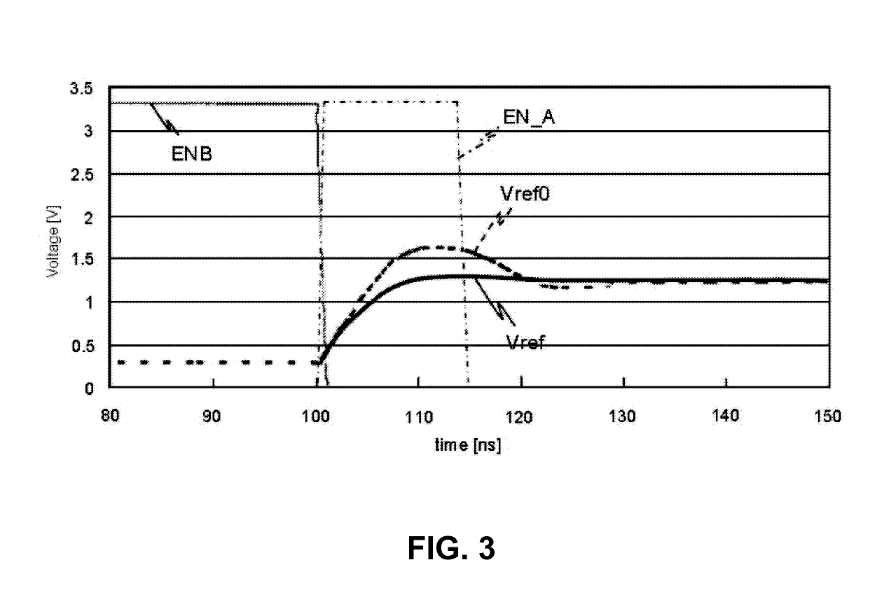

FIG. 3 is a time chart schematically showing simulation wave shapes of the input signals and the reference voltage Vref of the reference voltage generation circuit 10 immediately after the enable signal becomes the high level according to the first embodiment of the present invention. In FIG. 3, the horizontal axis represents an elapsed time, and the vertical axis represents a voltage.

As shown in FIG. 3, at the elapsed time of about 100 ns, the enable inversion signal ENB is changed from the high “H” level to the low “L” level. At the same time, the enable pulse signal EN_A is changed from the low “L” level to the high “H” level.

It should be noted that a reference voltage Vref0 is generated with a conventional reference voltage generation circuit at the output terminal n1, and is shown in FIG. 3 as a comparison. It is supposed that the conventional reference voltage generation circuit has a configuration similar to that of the reference voltage generation circuit 10 except the detour electrical current path. As shown in FIG. 3, the reference voltage Vref0 starts rising at the elapsed time of about 100 ns, and exhibits the overshoot until the elapsed time of about 120 ns.

On the other hand, in the first embodiment, the reference voltage Vref, which is generated with the reference voltage generation circuit 10, starts rising at the elapsed time of about 100 ns, and does not exhibit the overshoot until the reference voltage Vref becomes the desirable voltage value, for example, 1.25 V.

As described above, in the reference voltage generation circuit 10 in the first embodiment, the NMOS 1 is provided for maintaining the reference voltage Vref at the desirable voltage in the stable state, and the DMOS 3 is provided for raising the reference voltage Vref to the desirable voltage during the transition state. Further, the NMOS 1 is connected in parallel to the DMOS 3, thereby constituting the standard electrical current path 21 and the detour electrical current path 22.

In the first embodiment, during the transition state, the detour electrical current path 22 including the DMOS 3 becomes the conductive state, so that the reference voltage Vref is raised to the desirable voltage. In the stable state, the standard electrical current path 21 including the NMOS 1 becomes the conductive state, so that the reference voltage Vref is maintained at the desirable voltage. In other words, it is configured such that, when the transition state is switched to the stable state, the standard electrical current path 21 is switched to the detour electrical current path 22.

Further, as described above, the DMOS 3 is the depletion type having a faster switching response time, as opposed to the NMOS 1 of the enhancement type, to the change in the reference voltage Vref supplied into the gate thereof. Accordingly, the DMOS 3 is turned on immediately after the enable on. As a result, the detour electrical current path 22 becomes the conductive state to bypass the NMOS 1, and the reference voltage Vref is gradually increasing. Through the operation described above, even immediately after the enable on when the NMOS 1 is not turned on, it is possible to minimize the overshoot of the reference voltage Vref.

Further, in the first embodiment, the resistivity value of the NMOS 1 is set to the same or substantially the same as the resistivity value of the DMOS 3. Accordingly, when the standard electrical current path 21 is switched to the detour electrical current path 22, it is possible to prevent the reference voltage Vref from fluctuating.

Further, in the first embodiment, the DMOS 3 connected to the NMOS 2 in parallel becomes the on state for the specific period of time immediately after the enable on. In other words, the DMOS 3 becomes the off state after the pulse existing period of the enable pulse signal EN_A, so that no electrical current flows through the detour electrical current path 22.

In general, the depletion type NMOS tends to have poor temperature property as compared to the enhancement type NMOS. In the reference voltage generation circuit 10 in the first embodiment, it is configured such that the DMOS 3 becomes the on state after the specific period of time is elapsed after the enable on. Accordingly, it is possible to minimize the effect of the fluctuation of the reference voltage Vref due to the temperature change in the stable state.

If the NMOS 1 is the depletion type NMOS instead of disposing the DMOS 3 in parallel to the NMOS 1, the reference voltage Vref tends to be fluctuated to a larger extent due to the temperature change in the stable state. In the reference voltage generation circuit 10 in the first embodiment, however, the reference voltage Vref is generated using the NMOS 1 of the enhancement type in the stable state, thereby preventing the excessive fluctuation of the reference voltage Vref.

Further, in order to minimize the overshoot, a capacitor may be connected to the output terminal n1. In this case, however, it takes a long time to raise the reference voltage Vref. Accordingly, it takes a long time to stabilize an operation of a circuit to which the reference voltage Vref is supplied. In the reference voltage generation circuit 10 in the first embodiment, however, it is possible to minimize the overshoot without a capacitor connected to the output terminal n1. Accordingly, it is possible to quickly raise the reference voltage Vref.

In the first embodiment, the standard electrical current path 21 is formed of the pair of the NMOS 1 and the DMOS 6, and the present invention is not limited to the configuration. Alternatively, the standard electrical current path 21 may be formed of more than two pairs of transistors connected in series.

### Second Embodiment

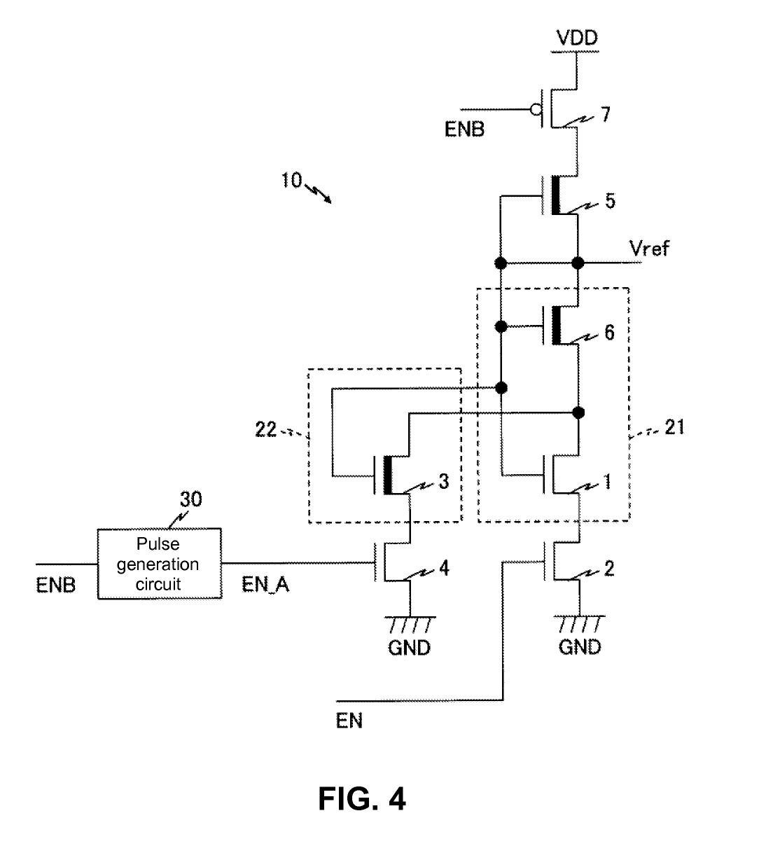

A second embodiment of the present invention will be explained next. FIG. 4 is a circuit diagram showing a configuration of the reference voltage generation circuit 10 according to the second embodiment of the present invention.

As shown in FIG. 4, the reference voltage generation circuit 10 includes a pulse generation circuit 30 in addition to the configuration of the reference voltage generation circuit 10 in the first embodiment. Other components in the second embodiment are similar to those in the first embodiment. The pulse generation circuit 30 is configured to generate the enable pulse signal EN_A from the enable inversion signal ENB, so that the enable pulse signal EN_A thus generated is input into the gate of the NMOS 4.

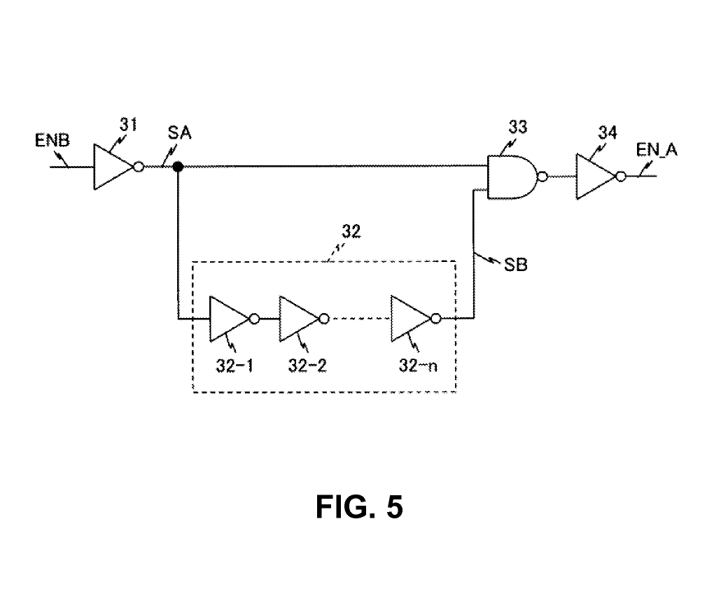

FIG. 5 is a circuit diagram showing a configuration of the pulse generation circuit 30 of the reference voltage generation circuit 10 according to the second embodiment of the present invention. As shown in FIG. 5, the pulse generation circuit 30 includes an inverter 31; a delay circuit 32; an NAND circuit 33; and an inverter 34.

In the second embodiment, the inverter 31 is configured to output a level inversion signal SA of the enable inversion signal ENB. The level inversion signal SA is input into the delay circuit 32 and one of input terminals of the NAND circuit 33. The delay circuit 32 is configured to delay the level inversion signal SA and invert the signal level thereof to obtain a level inversion delayed signal SB, so that the level inversion delayed signal SB is input into the other of the input terminals of the NAND circuit 33. The delay circuit 32 is formed of a plurality of inverters 32-1 to 32-n in the number of n (n is an odd number more than 3) connected in series.

In the second embodiment, the NAND circuit 33 is configured to perform an NAND operation on the level inversion signal SA input into one of the input terminals thereof and the level inversion delayed signal SB input into the other of the input terminals thereof, so that the NAND circuit 33 obtains and outputs an NAND signal to the inverter 34. The inverter 34 is configured to generate a level inversion signal of the NAND signal thus input, and output the level inversion signal as the enable pulse signal EN_A. It should be noted that the NAND circuit 33 and the inverter 34 substantially constitute a logical conjunction circuit.

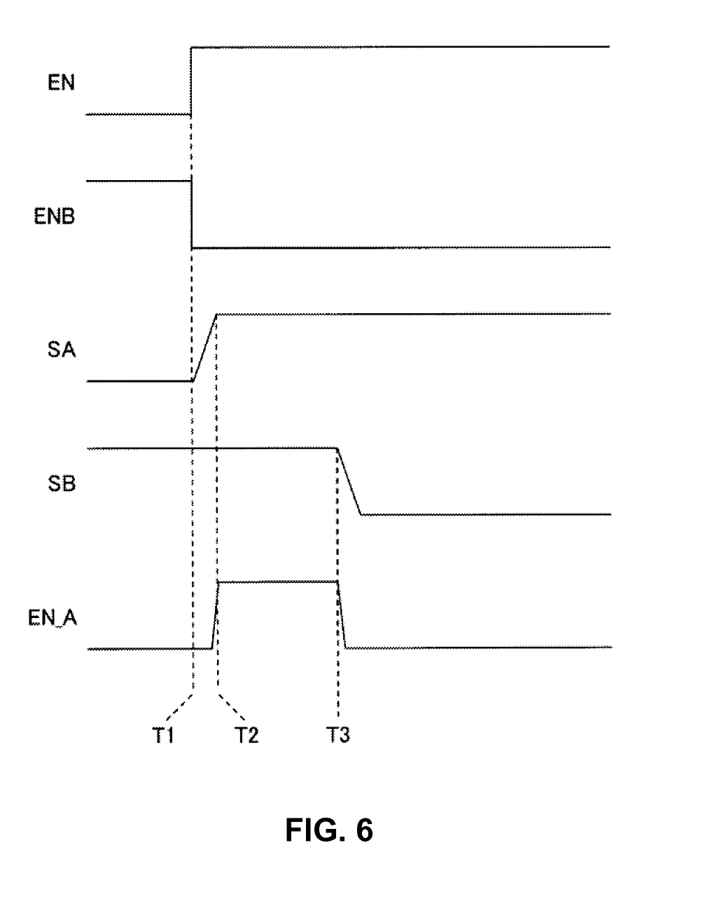

An operation of the pulse generation circuit 30 in the enable on will be explained next with reference to FIGS. 4 to 6. FIG. 6 is a time chart schematically showing wave shapes of input signals of the pulse generation circuit 30 of the reference voltage generation circuit 10 according to the second embodiment of the present invention.

As shown in FIG. 6, at the time T1, the enable signal EN is switched from the low “L” level to the high “H” level, and the enable inversion signal ENB is switched from the high “H” level to the low “L” level, respectively, that is, the enable on.

Immediately after the enable on, the level inversion signal SA supplied to one of the input terminals of the NAND circuit 33 is changed from the low “L” level to the high “H” level. Then, at the time T2, the signal level of the level inversion signal SA is completely changed. On the other hand, at the time T3 after a specific period of time is elapsed from the time T2, the level inversion delayed signal SB supplied to the other of the input terminals of the NAND circuit 33 is switched from the high “H” level to the low “L” level. The period of time from the time T2 to the time T3 corresponds to a delay time determined by the number of stages of the inverter 32-1 to 32-n constituting the delay circuit 32.

As shown in FIG. 6, the enable pulse signal EN_A is in the low “L” level before the enable on, and in the high “H” level at the time T2 and the time T3. Further, at the time T3, the enable pulse signal EN_A is switched again from the low “L” level to the high “H” level. As a result, the pulse generation circuit 30 generates one pulse of the enable pulse signal EN_A having a pulse width corresponding to the period of time from the time T2 to the time T3. After the pulse generation circuit 30 generates one pulse of the enable pulse signal EN_A, the enable pulse signal EN_A is input into the gate of the NMOS 4 (refer to FIG. 4). It should be noted that the operation of the reference voltage generation circuit 10 is similar to that in the first embodiment.

As described above, in the second embodiment, the reference voltage generation circuit 10 further includes the pulse generation circuit 30. Accordingly, it is possible to generate the enable pulse signal EN_A having one pulse from the enable inversion signal ENB. As a result, it is not necessary to separately input the enable pulse signal EN_A from an outside. Further, the pulse generation circuit 30 has the simple configuration as shown in FIG. 5 for generating the enable pulse signal EN_A.

### Third Embodiment

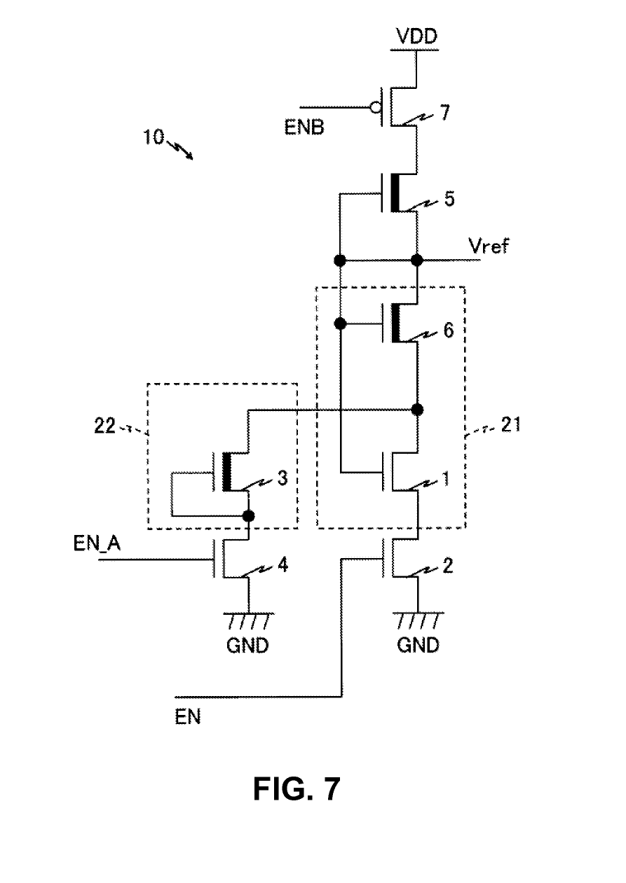

A third embodiment of the present invention will be explained next. FIG. 7 is a circuit diagram showing a configuration of the reference voltage generation circuit 10 according to the third embodiment of the present invention.

As shown in FIG. 7, different from the first embodiment, in the third embodiment, the gate of the DMOS 3 is not connected to the output terminal n1, instead is connected to the source of the DMOS 3. With the configuration, the DMOS 3 functions as a constant electrical current source in a normally on state. Other components in the third embodiment are similar to those in the first embodiment. It should be noted that the enable signal EN, the enable inversion signal ENB, the enable pulse signal EN_A, and the reference voltage Vref of the reference voltage generation circuit 10 are similar to those in the first embodiment shown in FIG. 2.

In the third embodiment, with the configuration described above, the detour electrical current path 22 including the DMOS 3 becomes the conductive state during the pulse existing period of the enable pulse signal EN_A, that is, the transition period. Accordingly, it is possible to raise the reference voltage Vref to the desirable voltage. Further, in the stable state, the standard electrical current path 21 including the NMOS 1 becomes the conductive state, so that it is possible to maintain the reference voltage Vref at the desirable voltage. Accordingly, similar to the first embodiment, it is possible to minimize the overshoot of the reference voltage Vref.

The disclosure of Japanese Patent Application No. 2012-232607, filed on Oct. 22, 2012, is incorporated in the application by reference.

While the invention has been explained with reference to the specific embodiments of the invention, the explanation is illustrative and the invention is limited only by the appended claims.

What is claimed is:

1. A reference voltage generation circuit, comprising:
a standard electrical current path including at least a pair of NMOS (an enhancement type NMOS field effect transistor) and PMOS (an enhancement type PMOS field effect transistor);
a constant electrical current supplying circuit for supplying a constant electrical current to the standard electrical current path; and
a timing compensation circuit,
wherein said NMOS and PMOS share a gate potential and a source-drain electrical current so that the reference voltage generation circuit generates a reference voltage as a potential difference between two positions sandwiching the NMOS and PMOS, and
said timing compensation circuit includes a compensation DMOS (a depletion type NMOS field effect transistor) for forming a detour electrical current path for bypassing the NMOS according to an on signal.

2. The reference voltage generation circuit according to claim 1, wherein said constant electrical current includes a constant electrical current source connected to one end portion of the standard electrical current path and a first switch connected to another end portion of the standard electrical current path.

3. The reference voltage generation circuit according to claim 1, wherein said timing compensation circuit further includes a second switch connected in series to the compensation DMOS, said second switch being turned on according to the on signal.

4. The reference voltage generation circuit according to claim 1, wherein said compensation DMOS has a gate potential substantially equal to a gate potential of the NMOS.

5. The reference voltage generation circuit according to claim 1, wherein said compensation DMOS includes a gate and a source connected to the gate.

6. The reference voltage generation circuit according to claim 1, wherein said compensation DMOS is configured to form the detour electrical current path at least from when the reference voltage starts rising up to when the reference voltage becomes a constant level.

7. The reference voltage generation circuit according to claim 1, wherein said compensation DMOS has an on resistivity value substantially equal to an on resistivity value of the NMOS.

8. The reference voltage generation circuit according to claim 1, further comprising a pulse generation circuit for generating the on signal having one pulse when a conductive signal is input for conducting the standard electrical current path,
wherein said timing compensation circuit is configured to conduct the detour electrical current path only when the one pulse exists.
